(19) United States
(12) Patent Application Publication
(10) Pub. No.: US 2012/0163953 A1
(43) Pub. Date: Jun. 28, 2012

(54) IMPROVEMENT TO PALLETIZING EQUIPMENT COMBINED WITH SECURE ACCESS

(75) Inventors: Pascal Murano, Octeville-Sur-Mer (FR); Philippe Carry, Octeville-Sur-Mer (FR)

(73) Assignee: SIDEL PARTICIPATIONS, OCTEVILLE-SUR-MER (FR)

(21) Appl. No.: 13/386,091

(22) PCT Filed: Jul. 20, 2010
(86) PCT No.: PCT/FR2010/051521

§ 371 Date: Jan. 20, 2012

(30) Foreign Application Priority Data
Jul. 22, 2009 (FR) 09 55123

(51) Int. Cl. B65G 57/02

(52) U.S. Cl. 414/788.1

(57) ABSTRACT

The invention relates to equipment including a robotized palletizing station comprising a robot (10) to which objects on a pallet (3) are accessible, said robotized palletizing station being placed in a closed chamber (1) provided with a door (7) providing access to said palletizing station, said station being provided with a cradle (17), said cradle consisting of a stationary portion (18, 19, 20, 21), provided so as to center and guide the pallet when it is partially fed into said palletizing station, and a movable portion (29, 22) that picks up said pallet (3) so as to place it in a reference position in said palletizing station, as well as to take said pallet from said reference position after it has been filled. The equipment is characterized in that said station comprises means for detecting the position of said pallet in relation to said reference position, as well as means for securing said station, the means for detecting the position of the pallet and the means for securing the station being combined with means for controlling the operation of said robot.

The present invention relates to an improvement to equipment which comprises, in a combined manner, a robotized station for palletizing cardboard boxes and a packaging machine which forms said boxes and fills them with pre-packaged products.

In the field of automated palletization, it is well known that robotized equipment of whatever kind generally presents a significant danger to the operators who are required to approach the robot.

Also, for this type of robotized palletizing equipment, the operations of removing full pallets and inserting empty pallets are generally carried out by means of a conveyor of the automatic type; however, such equipment involves the use of a much greater floor area.

For compact equipment, such as that which forms the subject of the invention, where the robotized palletizer is combined directly with a machine which packages products, it is standard practice to ensure that the equipment is safe, i.e. to stop the robot, when a manual intervention must be carried out by a operator, such as the removal of a pallet which is full of boxes or such as the insertion of an empty pallet, during the entire time necessary for the operation.

However, stopping the palletizing robot also involves stopping the packaging machine with which it is associated.

These stoppages of the packaging machine cause losses in production and they can also interfere with production upstream such as, for example, the labelling or the primary packaging of the products.

One of the purposes of the invention is therefore, on the one hand, to ensure the safety of the operator or operators during the phases of removing a full pallet and inserting an empty pallet and, on the other hand, to avoid stopping the equipment during pallet changes while limiting the floor area required by the equipment.

From the document FR 2 921 636 safe palletizing equipment is known which comprises two palletizing stations separated by a fixed wall and a movable cowling ensuring the closing of one or other station, alternatively. A robot is utilized to fill the pallet which is situated in the first palletizing station which is accessible to it (not closed by the movable cowling). When the pallet is full, the cowling moves in order to close the first palletizing station. Thus, an operator can recover the pallet located in the first closed station in complete safety while the robot is filling a new pallet in the second station.

Moreover, from the document US 2005/0175436 safe palletizing equipment comprising a station which can receive two pallets on a platform which is movable between two positions is known. In a first position of the movable platform, a first pallet is filled by a robot while a second pallet is introduced alongside, awaiting filling. In a second position of the movable platform, the first full pallet is removed from the station to be dealt with by a operator, while the second pallet is filled by a robot in the station. The equipment thus ensures the safety of the operator who recovers only the pallets which are removed from the station, at the same time as a continuous filling of pallets.

Such equipment correctly ensures the safety of an operator while allowing a continuous filling of the pallets. However, it has the drawback of being bulky.

A subject of the invention is to propose an alternative design solution which is as safe as the solutions disclosed above, which also ensures continuous filling of the pallets, and which is much less bulky than the known solutions.

To this end the invention relates to equipment comprising a robotized palletizing station comprising a robot capable of picking up boxes on leaving a machine in order to arrange them on a pallet which adjoins said exit, said machine and said robotized palletizing station being arranged in the same closed chamber provided with a door providing access to said palletizing station, said robotized palletizing station being provided with a cradle, which cradle is constituted:
by a stationary portion which is provided so as to centre and guide the pallet when it is partially fed into said palletizing station,
and, associated with this stationary portion, by a movable portion which picks up said pallet, on the one hand, in order to place it in a reference position in said palletizing station and, on the other hand, to take it from said reference position after it has been filled.

The equipment according to the invention is notable in that said station comprises:
means for detecting the position of said pallet relative to said reference position,
as well as means for securing said station,
the means for detecting the position of the pallet and the means for securing the station being combined with means for controlling the operation of said robot.

Thus the invention offers the same high level of safety as that proposed by the solutions of the state of the art: (i) The means for detecting the pallet, combined with the means for controlling the robot, make it possible to limit the action of the robot to a work zone which is safe for the operator, at a distance from the latter when he removes a full pallet from the station, (ii) The combination of the securing means with the means for controlling the robot provide a second stage of safety for the operator, since their presence allows the robot to be secured, i.e. stopped, if the operator triggers them (for example when entering the palletizing station).

The combination of these three means (securing—detection of the position of the pallet relative to a reference position in the cradle—control of the robot) make it possible to limit the space occupied by the cradle in the station. In fact, a palletizing station requiring slightly more space than that occupied by a single pallet is sufficient, as the securing means and position-detection means are sufficient to control the stopping of the robot or its work in a restricted buffer zone which is safe for the operator. There is therefore no longer any need to provide a station which can receive two pallets, as in the state of the art presented above.

According to the invention, the means for detecting the position of the pallet in the cradle can comprise at least one sensor positioned on the movable structure of the cradle.

Within the framework of an embodiment which is presented below, the means for securing the station comprise at least one array of photoelectric cells arranged in the chamber in proximity to said door providing access to said station.

Still according to the invention, said stationary portion of the cradle comprises a slider bed positioned in the axis of the door for the pallet to pass through, which slider bed comprises, on the one hand, longitudinal guides arranged laterally, so-called lateral guides, and spaced apart by a width which is substantially greater than that of the pallet and, on the other hand, stops at its end, which stops act as a reference frame for the longitudinal positioning of the pallet at the palletizing station.

According to another arrangement of the invention, the lateral guides are fixed and have a height which is of the order of one-third of the thickness of the pallet.

Preferably, the upstream portion of the lateral guides is rounded in order to facilitate the introduction of the pallet.

Moreover, the height of the rounded upstream portion of the lateral guides is substantially equal to the thickness of said pallet.

According to another arrangement of the invention, the stops forming the longitudinal reference frame at the end of the slider bed are adjustable.

Still according to the invention, the movable portion of the cradle is constituted by a U-shaped structure arranged flat and open towards the pallet entry-exit door, which structure is guided longitudinally over the slider bed and it comprises movable lateral walls capable of gripping the sides of said pallet, above the level of the fixed guides of said slider bed, which movable walls comprise, at their end situated towards said entry-exit door, a right-angle fold which makes it possible to frame and grasp said pallet and, during its introduction into the palletizing station, the folds in question make it possible to wedge said pallet against the stops of said fixed slider bed which, with said lateral walls of the U-shaped structure, form the reference frame of said pallet at the palletizing station.

According to another arrangement of the invention, the movable portion of the cradle is carried by roller slides cooperating with rails arranged on each edge of the fixed slider bed of said cradle and actuators, such as cylinders for example, are interposed between the crosspiece which forms the base of the U and a fixed support.

Still according to the invention, said fixed support is integral with said slider bed.

Other advantages and characteristics of the equipment according to the invention will be better understood from the following description of several embodiment variants given by way of non-limitative examples, with reference to the attached drawings in which:

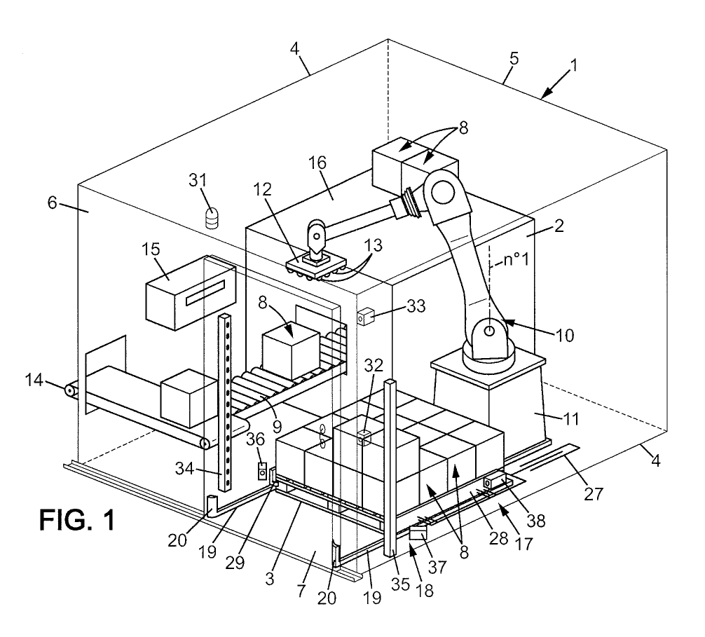

FIG. 1 is a general diagrammatic perspective view of equipment according to the invention which combines a product-packaging machine and a palletizing station;

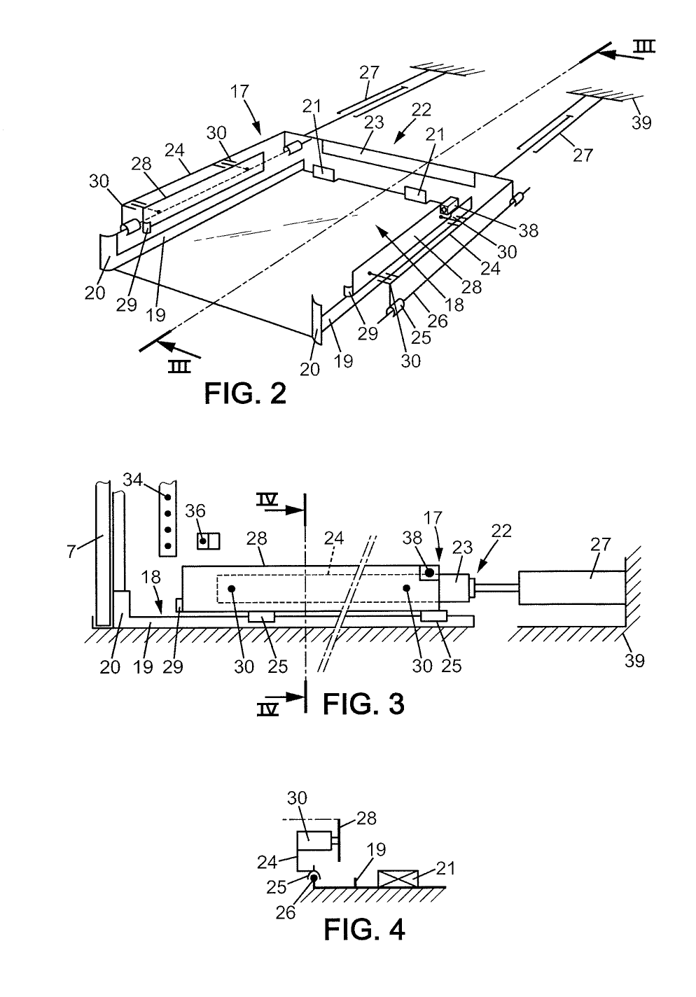

FIG. 2 is a diagrammatic perspective view of the palletizing station of the equipment according to the invention;

FIG. 3 is a diagrammatic longitudinal cross-sectional view, along the plane III-III in FIG. 2, of the palletizing station of the equipment according to the invention;

FIG. 4 is a diagrammatic partial cross-sectional view, along the plane IV-IV in FIG. 3, of the slider bed and the cradle of the palletizing station of the equipment according to the invention;

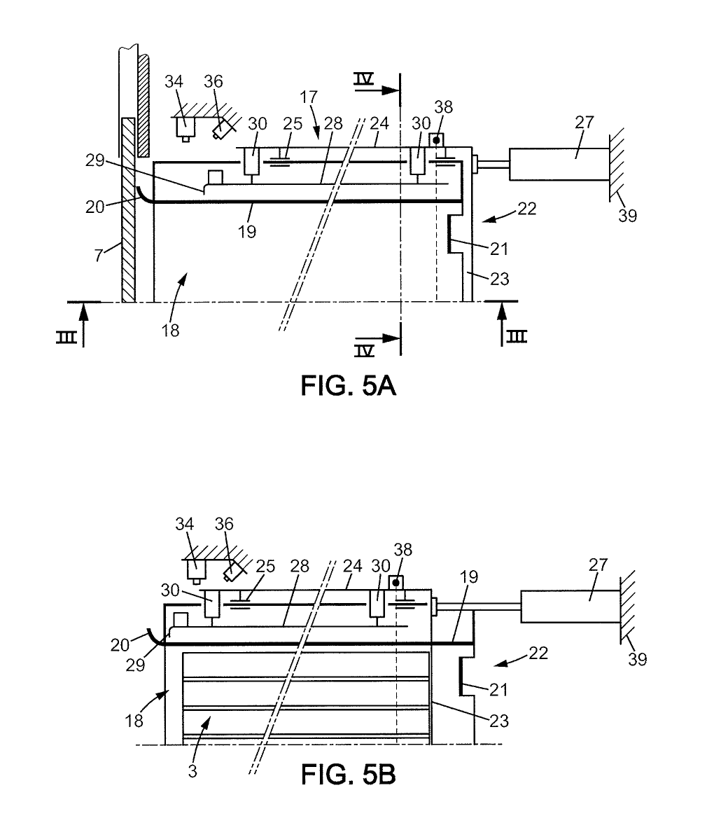

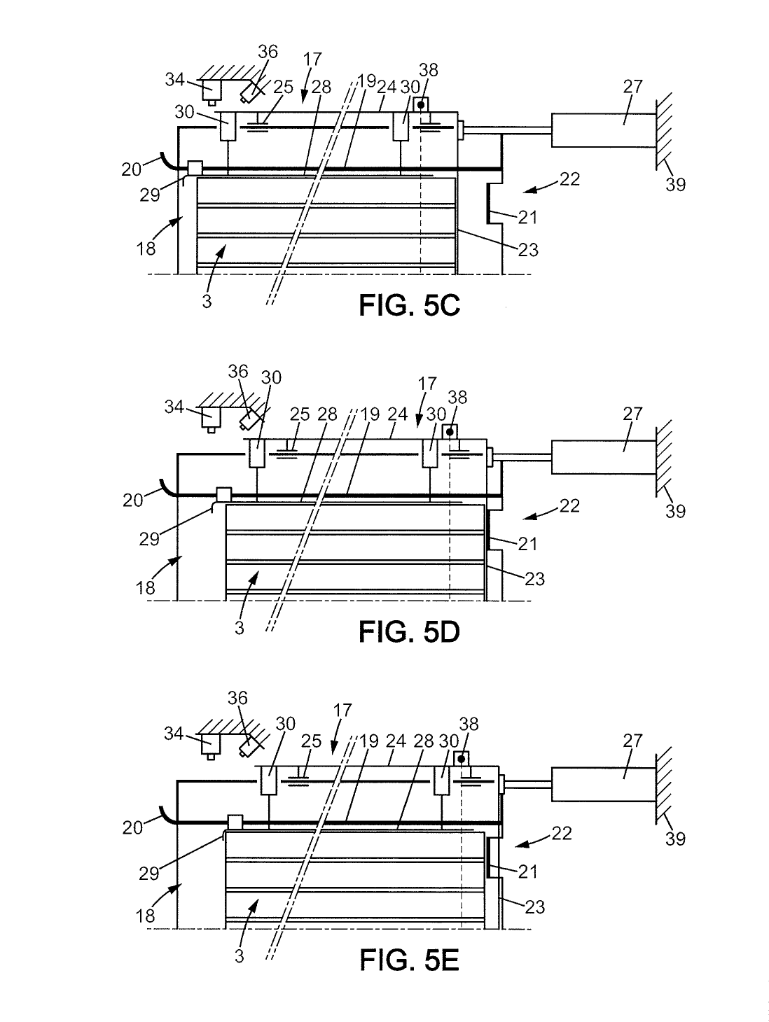

FIGS. 5A to 5E are diagrammatic partial plan views of the palletizing station of the equipment according to the invention during the different stages of positioning of a pallet in said palletizing station.

With reference to FIG. 1, the equipment according to the invention comprises, assembled in a chamber 1 which is closed, a product-packaging machine 2 and a station for the pallet 3 where the automatic palletizing operation is carried out.

The chamber 1 is closed by side walls 4, a rear wall 5 and a front wall 6 which comprises a door 7 for allowing access to the pallet 3 which is situated at the palletizing station, the side 4, rear 5 and front walls 6 being advantageously translucent.

The packaging machine 2 is, for example, a machine of the type of that described in the document FR 2 907 100. It is fed with products in a regular manner by means of a conveyor, not shown in FIG. 1, which introduces said products through the rear wall 5 of the chamber 1. This machine 2 also comprises a magazine, not shown in FIG. 1, which makes it possible to feed it with cardboard blanks for forming boxes 8 in which the products are positioned, said boxes 8 leaving said machine 2 on a conveyor 9 which extends longitudinally into the chamber 1.

A robot 10 is arranged in proximity to the palletizing station, on the side of the packaging machine 2. This robot 10 is mounted on a base 11 which is placed on the floor or which is integral with the general chassis of all the equipment. This robot 10 comprises a polyarticulated arm and it pivots about its main axis no. 1 which is a vertical axis, which axis no. 1 corresponds to the first axis with respect to the base 11.

The robot 10 could comprise several arms without exceeding the scope of the invention.

This robot 10 is equipped with a gripping head 12 which is situated at the end of its arm. This gripping head 12, equipped with suction cups 13, picks up the boxes 8 in order to arrange them in an appropriate layout on the pallet 3.

The volume in the chamber 1, in which the robot 10 is permitted to manoeuvre, is programmed in a control unit, not shown in FIG. 1, for driving said robot 10 and this control unit, of the automatic type, is integrated with said chamber 1.

All of the equipment operates with this control unit for driving the robot 10, which is loaded with appropriate programs for operating the robot 10 and, in particular, for allowing the operation of palletizing the boxes 8 according to a layout suited to said boxes 8 and to the pallet 3.

This robot 10 can also cooperate with complementary equipment such as, for example, a conveyor 14 arranged at the downstream end of the conveyor 9, which conveyor 14 recovers any waste in order to transfer it outside the equipment.

The robot 10 can additionally cooperate with a device 15 which carries out the labelling of the boxes 8 before arranging them on the pallet 3.

The packaging machine 2 operates continuously; it operates at the rate at which it is supplied with products. The robot 10 ensures the palletizing of the boxes 8 as they leave the machine 2; its head 12 for gripping the boxes 8 is moved within a predefined volume, dedicated to its manoeuvring, which is programmed in the control unit for driving the robot 10.

This predefined volume is included in the chamber 1 and is dedicated to the arrangement of the boxes 8 on the pallets 3 according to the distribution layout envisaged.

When the pallet 3 is full, the robot 10 is programmed to continue operating and to pick up the boxes 8 which continue to leave the packaging machine 2.

The installation comprises a buffer zone which is presented in the form of a platform 16 arranged, for example, above the packaging machine 2 and this buffer zone allows the robot 10 to temporarily deposit the boxes 8, for the time when an operator intervenes in order to remove the pallet 3, which is full, and install a new pallet in the palletizing station.

In order to allow the operator to intervene in complete safety, the robot 10 comprises means for controlling its operation. Such means for controlling the robot make it possible to limit the maximum amplitude of its movements in the predefined volume in which the gripping head 12 manoeuvres. These means of control, or of limitation of the amplitude, carried out on the basis of programmable systems, electric cams, and mechanical stops make it possible to define, authorise and/or prohibit sectors of manoeuvring of the robot 10 about its main axis no. 1.

Using this amplitude limitation device, the control unit for driving the robot 10, manages all of the movements of said robot 10 while ensuring that it does not leave the work zone which is programmed. More precisely, this driving control unit comprises means for defining the work spaces in which said robot is authorised to operate as well as means for stopping it immediately and completely if it leaves these authorised operating spaces.

The palletizing station, the palletizing station of the equipment according to the invention comprises, with reference to FIGS. 1, 2 and 3, a cradle 17 constituted by a stationary portion which is arranged so as to centre and roughly guide the pallet 3 during its partial introduction into said palletizing station by an appropriate handling device. The palletizing station also comprises, associated with this stationary portion, a movable portion which picks up said pallet 3, on the one hand to place it in its reference position in said palletizing station and, on the other hand, to remove it after it has been filled.

Said stationary portion of the cradle 17 comprises, with reference to FIGS. 1 and 2, a slider bed 18 positioned in the axis of the opening of the door 7 through which the pallet 3 passes. This slider bed 18 comprises longitudinal guides 19 arranged laterally, so-called lateral guides, and spaced apart by a width which is substantially greater than that of the pallet 3. Said lateral guides 19 are fixed and have a height which is of the order of one-third of the thickness of the pallet 3. The upstream or proximal portion of each of the lateral guides 19, i.e. the portion of each of the lateral guides 19 closest to the door 7 through which the pallet 3 passes, is rounded in order to form a shoe 20 having a height substantially equal to the thickness of said pallet 3 in order to facilitate the introduction of the latter into the palletizing station. The convexity of the rounding of the shoes 20 is orientated towards the outside of the door 7, through which the pallet passes, forming the access from the outside to the palletizing station.

In the downstream or distal portion of the slider bed 18, i.e. the portion of the slider bed 18 furthest from the door 7 through which the pallet 3 passes, the latter comprises stops 21 which act as a reference frame for the longitudinal positioning of the pallet 3 at the palletizing station. These stops 21 form the longitudinal reference frame at the end of the slider bed 18, i.e. they delimit a reference position in the cradle. They are moreover adjustable.

It is obvious that the slider bed 18 may comprise only a single stop 21 without however exceeding the scope of the invention.

Moreover, the movable portion of the cradle 17 is constituted by a U-shaped structure 22 arranged flat and open towards the entry-exit door for the pallet. Said structure 22 comprises a base 23 and two branches 24 extending towards the entry and exit door 7 for the pallet 3. This structure 22, with reference to FIGS. 3 and 4, is carried by roller slides 25 mounted loose under the branches 24 of said structure 22, said slides 25 sliding on rails 26 arranged on each edge of the fixed slider bed 18 of said cradle.

It is self-evident that the slides 25 can be replaced by any other means allowing a longitudinal translation of the structure 22 without exceeding the scope of the invention.

With reference to FIGS. 1 to 3, actuators, such as pneumatic or electric cylinders 27, for example, are interposed between a fixed support 39 and the crosspiece which forms the base 23 of the U-shaped structure 22, said actuators 27 being controlled by the control unit for driving the robot 10 and/or by an operator by means of control buttons. Said fixed support 39 is preferably integral with said slider bed 18.

Moreover, with reference to FIGS. 2 and 3, the structure 22 comprises, along the inner edge of each branch 24, a lateral wall 28 mounted in a movable fashion relative to said branch 24 so that it is capable of moving horizontally and transversally between the branches 24. Each lateral wall 28 consists of a vertical wall extending above the level of the lateral guides 19 of the fixed slider bed 18 and comprises at its proximal end, i.e. at its end closest to the entry-exit door 7 of the palletizing station, a right-angle fold 29, oriented towards the sagittal plane of the U-shaped structure 22, which makes it possible to frame and grasp the pallet 3. Each lateral wall 28 is integral with the rods of actuators 30 the bodies of which are carried by the inner surface of each branch 24 of the structure 22. The actuators 30 preferably consist of pneumatic or electric cylinders controlled by the control unit for driving the robot 10 and/or by an operator by means of control buttons.

In this manner, the lateral walls 28 are capable of gripping the sides of said pallet 3, above the level of the fixed lateral guides 19 of said slider bed 18. The folds 29 of the movable lateral walls 28 make it possible to frame and grasp said pallet 3 and, during its introduction into the palletizing station, the folds 29 in question make it possible to wedge said pallet 3 against the stops 21 of said fixed slider bed 18 which, with said lateral walls 28 of the U-shaped structure 22, form the reference frame of said pallet 3 in the palletizing station.

Moreover, on at least one of the walls 28 of the movable portion of the cradle 17, detection means 38 are provided which are situated at the base of the U-shaped structure 22, which means are capable of detecting the presence of a pallet 3 in the cradle (FIG. 3).

These detection means 38, produced for example by sensors, make it possible to avoid stoppages of the equipment when changing the pallet 3 and to improve the safety of the operator during stages of installation and/or removal of the pallet 3. In fact, when the detection means 38 register that the pallet has left the reference position, i.e. when it is taken by the movable portion of the cradle towards the door in order to be removed by a operator, the means 38 inform the means for controlling the robot which then works only in the buffer zone 16 where it temporarily stores items.

Thus, when the sensors 38 communicate with the means for controlling the operation of the robot. If they register that the pallet is situated outside the reference position in the cradle, then the robot works in the buffer zone 16. If the sensors 18 register that the pallet is situated in the reference zone, then the robot loads the pallet with the boxes 8.

Thus, with reference to FIG. 1, when the pallet 3 is full, and the operator intervenes in order, on the one hand, to remove this full pallet and, on the other hand, to position a new pallet 3, the intervention space of the robot 10 is limited to a restricted sector, i.e. to a sector which allows the robot 10 to grasp the boxes 8 leaving the machine 2 and place them in the temporary storage zone, on the platform 16 which acts as a buffer.

In this restricted sector, the control unit for driving the robot 10 can be programmed so that the latter operates at speeds which are lower than those that it uses in the sector corresponding to its normal operating cycle.

In order to carry out this operation of removing a full pallet and introducing a new pallet 3, the operator is first alerted. Means, constituted by a luminous or other type of warning device 31, installed on the chamber 1, indicate to the operator that the pallet 3 is full.

In order to carry out an operation of removal of the pallet whether it is full or not (in the case where the operator wishes to remove one pallet and replace it with another) and in order to install a new pallet 3 in the structure 22 of the palletizing zone, the operator has a switch-type component 32. This switch 32 makes it possible for him to transmit to the control unit for driving the robot 10, his intention to access the palletizing station.

In this case, the robot 10 completes its task in progress and will position itself in the restricted sector. From that moment, via the driving control unit, the robot 10 is confined in this sector, i.e. in the restricted sector which allows it, in particular, to take the boxes 8 at the exit from the machine 2 and temporarily deposit them on the platform 16.

The working speed of the robot 10, during the normal palletizing cycle, is sufficiently high to allow it subsequently to again pick up the boxes 8 stored on the platform 16 and arrange them on the pallet 3 with the other boxes leaving the packaging machine 2.

On the other hand, from the moment when the robot 10 is situated in the restricted sector, a luminous signal of the warning-light type, associated with the switch 32, indicates to the operator that all the safety conditions are met and that he is permitted to open the door 7.

Still with regard to the safety of the operator, the equipment comprises a sensor 33 which cooperates with the door 7 in order to indicate to the control unit for driving the robot 10, that said door 7 is in the closed position or in the open position.

This sensor 33 makes it possible to secure the equipment if the door 7 is handled by any person without prior permission, i.e. before the warning light of the switch 32 is lit up.

Moreover the door sensor 33 can be of the interlocked type, i.e. it is impossible to open the door from the outside unless the control unit for driving the robot 10 has transmitted the information that the robot 10 has fully stopped.

Given that the robot 10 operates in its restricted space when the door 7 is open, a light curtain makes it possible to secure the equipment (securing means), i.e. to stop it, if the light curtain is cut in particular by the operator or another person entering the chamber 1 by the door 7.

This curtain, with reference to FIG. 1, is constituted by substantially vertical strips 34 and 35, comprising photoelectric cells. The strips 34 and 35 are arranged in the chamber 1, in proximity to the door 7 in order to detect the intrusion of an operator or an item. The strips 34 and 35 are however provided at a certain distance from the door, behind the frame of the latter, in order to avoid any untimely stopping of the machine, for example due to too great a movement of the arm of an operator operating a pallet truck in order to remove the full pallet from the station.

The bottom-lower ends of the strips 34 and 35 of this light curtain are arranged at a certain distance from floor level, of the order of 30 cm, for example; said curtain is in fact situated at a level which is above the upper level of the pallet 3, when it is empty, so as to allow the introduction of this pallet 3 under the light curtain into the U-shaped structure 22, at the palletizing station, without the risk of cutting the beams from the cells of said light curtain.

In order to improve safety, this light curtain can also comprise a first programmable active zone which extends from the lower end of the strips to a height corresponding to that of the full pallet of the current series and a second zone, also active, but in a permanent manner for this series.

The active first zone of the light curtain can be brought into an inactive situation, while the full pallet 3 is being removed. Means make it possible to inhibit this first active zone of the light curtain; they are constituted, for example, by a pair of cells 36 and 37, which are situated inside the chamber 1.

At the moment when it leaves, the full pallet cuts the inhibiting beams from the cells 36 and 37 before those of the light curtain, which has the effect, via the control unit of the curtain, of deactivating said curtain during the leaving phase of said full pallet.

The inhibition of the light curtain is cancelled when the full pallet 3 is no longer opposite the beams from the inhibiting cells 36 and 37 and has left the zone of the light curtain. The duration of the inhibition is limited and, if the latter is too long, the control unit of the light curtain causes an emergency stoppage of the equipment.

The introduction of a new pallet 3 into the palletizing station is carried out without cutting the different beams as said empty pallet passes under the level of the different beams.

Moreover, as indicated previously, the equipment comprises a sensor 38 which makes it possible to indicate to the control unit for driving the robot 10, the presence or the absence of a pallet 3 at the palletizing station.

After the removal of the full pallet and the re-positioning of an empty pallet, the operator again closes the door 7 and restarts the normal cycle of the robot 10 by a new intervention on the switch 32. After validation by the sensor 33 that the door 7 is closed, the robot 10, under the control of the driving control unit, resumes its activity namely: gripping the boxes 8 on the conveyor 9 leaving the packaging machine 2 and/or gripping the boxes 8 stored on the platform 16 for palletizing.

An explanation now follows of the operation of the station of the equipment according to the invention during the introduction of a new pallet 3 into the palletizing station and during the removal of the full pallet with reference to FIGS. 1 and 5A to 5E.

After the appearance of the end-of-pallet signal on the warning light 31, the operator actuates the switch 32, with reference to FIGS. 1 and 5A, thus transmitting to the control unit for driving the robot 10 his intention to access the palletizing station. The driving control unit then authorizes the opening of the door 7 and allows the movement of the U-shaped structure 22 towards the door 7 until the folds 29 of the lateral walls 28 extend in proximity to the door entrance (FIG. 5B). With reference to FIG. 5B, a pallet 3 is then positioned on the slider bed 18 by any appropriate means between the lateral walls 28 of the U-shaped structure 22, by passing it under the level of the means of control of access constituted by the strips 34 and 35 and the cells 36 and 37, until said pallet 3 is resting against the crosspiece 23 forming the base of the U-shaped structure 22. With reference to FIG. 5C, the lateral walls 28 are then moved towards the sagittal plane of the slider bed 18 from their retracted position to their active position where said lateral walls 28 are resting against the side panels of the pallet 3, by means of the cylinders 30. With reference to FIG. 5D, the U-shaped structure 22 is then moved, by means of the cylinders 27 and slides 25 guided on the rails 26 arranged on each edge of the fixed slider bed 18 of said cradle, towards the downstream portion of the palletizing station, carrying the pallet 3 towards the base of the slider bed 18 until said pallet 3 comes to rest against the stops 21 of the latter. With reference to FIG. 5C, the translation movement of the U-shaped structure 22 is then continued towards the downstream portion of the palletizing station until the folds 29 of the lateral walls are resting against the upstream wall of the pallet 3 in order to ensure that it is retained FIG. 5E.

During the removal of the pallet 3 from the palletizing station, the reverse movement is carried out so that the full pallet is partially removed using the movable portion of the cradle 17 and, in particular, the base 23 of the structure 22 and the lateral walls 28, over a distance which makes it possible to partially place this full pallet outside the means of control of access, as the retaining means are brought into the inactive position, before or after the partial movement of said full pallet, in order to release said full pallet relative to the means for centering and retaining said cradle 17 and, finally, said full pallet is completely removed with an appropriate handling device.

The door 7 can also comprise a lower skirt guaranteeing that the movable portions 28 and 29 cannot be accessed.

Thus, it will be observed that the operator does not enter the equipment, which increases safety for the operator and, above all, with a zone for intermediate storage of the cartons, this original arrangement makes it possible to avoid the stoppages of the equipment during the change of pallet and it makes it possible to improve the accuracy of the positioning of the pallet in its reference frame, in the palletizing station. In fact, this positioning breaks down into two very distinct phases: a first phase with intervention of the operator in order to partially and “roughly” introduce the empty pallet onto the stationary portion of the cradle 17, and a second, completely automated phase for positioning said empty pallet in its reference frame by means of the movable portion of said cradle, all of which can take place in conjunction with the limitation of the intervention zone and the limitation of the speed of movement of the palletizing head 12 installed on the robot 10.

Moreover, it should be understood that the pallet handling device could be suited to other types of installations requiring palletizing, without however exceeding the scope of the invention.

1.-12. (canceled)

13. An equipment comprising a robotized palletizing station comprising a robot capable of picking up boxes from an exit of a machine in order to arrange said boxes on a pallet which adjoins said exit,
said machine and said robotized palletizing station being arranged in a same closed chamber provided with a door providing access to said palletizing station,
said robotized palletizing station being provided with a cradle, said cradle comprising:
a stationary portion which is arranged so as to centre and guide said pallet during a partial introduction of said pallet into said palletizing station,
and, associated with said stationary portion, a movable portion which picks up said pallet in order, on the one hand, to place said pallet in a reference position in said palletizing station and, on the other hand, to take said pallet from said reference position after said pallet has been filled,
said equipment comprising
means for detecting a position of said pallet relative to said reference position,
as well as means for securing said palletizing station,
the means for detecting the position of said pallet and the means for securing said palletizing station being combined with means for controlling the operation of said robot.

14. The equipment according to claim 13, wherein the means for detecting the position of the pallet comprise at least one sensor positioned on said movable portion of the cradle.

15. The equipment according to claim 13, wherein the means for securing said palletizing station comprise at least one strip of photoelectric cells arranged in said closed chamber in proximity to said door providing access to said palletizing station.

16. The equipment according to claim 13, wherein said stationary portion of the cradle comprises a slider bed positioned in the axis of the opening of the door through which the pallet passes, which slider bed comprises, on the one hand, lateral guides arranged laterally, and spaced apart by a width which is substantially greater than the width of the pallet and, on the other hand, stops at the end of said slider bed, said stops acting as a reference frame for a longitudinal positioning of said pallet at the palletizing station.

17. The equipment according to claim 16, wherein the lateral guides are fixed and have a height which is of the order of one-third of the thickness of the pallet.

18. The equipment according to claim 16, wherein the lateral guides have upstream portion which is rounded in order to facilitate the introduction of the pallet.

19. The equipment according to claim 18, wherein the height of the upstream portion of the lateral guides is substantially equal to the thickness of the pallet.

20. The equipment according to claim 16, wherein the stops, forming a longitudinal reference frame at the end of the slider bed, are adjustable.

21. The equipment according to claim 16, wherein the movable portion of the cradle is constituted by a U-shaped structure arranged flat and open towards the door for the pallet, said structure being guided longitudinally on the slider bed and comprising movable lateral walls capable of gripping sides of said pallet, above a level of the lateral guides of said slider bed, which movable walls comprise, at their end situated towards said door, a right-angle fold which makes it possible to frame and grasp said pallet and, during an introduction of said pallet into the palletizing station, the folds make it possible to wedge said pallet against the stops of said slider bed which, with said lateral walls of the U-shaped structure, form the reference frame of said pallet in the palletizing station.

22. The equipment according to claim 16, wherein in that the movable portion of the cradle is carried by roller slides cooperating with rails arranged on each edge of the slider bed of said cradle and actuators are interposed between the crosspiece which forms the base of the U and a fixed support.

23. The equipment according to claim 22, wherein that the actuators comprise cylinders.

24. The equipment according to claim 22, wherein said fixed support is integral with said slider bed.
